(19) United States
(12) Patent Application Publication
(10) Pub. No.: US 2003/0127169 A1
(43) Pub. Date: Jul. 10, 2003

(54) Elastomers with long chain crosslinks to increase abrasion resistance

(75) Inventors: William L. Hergenrother, Akron, OH (US); James D. Ulmer, Akron, OH (US)

Correspondence Address: Chief Intellectual Property Counsel, Bridgestone/Firestone, Inc., 1200 Firestone Parkway, Akron, OH, 44317-0001, US

(73) Assignee: Bridgestone/Firestone, Inc.

(21) Appl. No.: 10/020,547

(22) Filed: Oct. 30, 2001

(51) Int. Cl. C08L 51/08; C08G 63/91; C08G 63/48; B60C 5/00

(52) U.S. Cl. 152/450; 525/326.3

(57) ABSTRACT

A long chain crosslinked elastomeric composition of matter comprises 100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof; from about 1 to about 15 parts by weight of a difunctional crosslinking agent, per 100 parts by weight of the rubber, having the structure Yₘ(SRS)ₙYₘ where Y is selected from the group consisting of H, SR′ and SiR′₃; where R is selected from the group consisting of branched and linear C2 to C20 alkylene, C6 to C20 arylene, C7 to C20 alkyarylene and C4 to C20 cycloalkylene groups and R″XR″; where R′ is selected from the group consisting of branched and linear C1 to C10 alkyl, C6 to C10 aryl, C7 to C10 alkyaryl and C4 to C10 cycloalkyl groups; where R″ is selected from the group consisting of branched and linear C2 to C10 alkylene, C6 to C10 arylene, C7 to C10 alkyarylene and C4 to C10 cycloalkylene groups and R″ can be the same or different; where X is selected from the group consisting of O, S, NH, NR′ and mixtures thereof; where m is 0 or 1 and n is 1 to about 100; from 0 to 5 parts by weight of sulfur; and from about 0.2 to about 10 parts by weight of at least one accelerator. A method for making such long chain compositions of matter is provided as are rubber articles and component for pneumatic tires comprising such crosslinked compositions of matter.

### BACKGROUND OF THE INVENTION

This invention relates generally to the preparation of vulcanized unsaturated elastomers with long chain crosslinks. It is often desirable to produce rubber compounds affording superior abrasion resistance or superior thermal stability, or both. Such rubber compounds, when fabricated into components for pneumatic tires, including tread plies, will exhibit properties of increased useful tread life and consistent performance. Fabrication of other components such as sidewalls and abrasion gum strips will also provide tires having better performance. In addition to pneumatic tires, other articles manufactured from vulcanized elastomers, such as bushings, belts, air spring, mounts and the like, will benefit from elastomeric compositions having increased abrasion resistance.

Abrasion resistance of tire treads is generally expressed in terms of the amount of tire material that is removed from the tread during normal wear. Abrasion resistance is often gauged in the laboratory on a Lambourn abrasion tester at room temperature with a slip angle of 65%. The results are expressed as the Lambourn Abrasion Index, which is the rate of weight loss of a chosen reference standard, divided by the rate of weight loss of the rubber compound of interest. Of course, less abrasion loss and a higher index are better.

As the level of performance expected from an automotive tire increases continuously, a rubber having good abrasion resistance is desired as the rubber for the tire tread for such tires.

Improvements in crosslink stabilities, have traditionally been sought and achieved with a view toward decreasing the amount of sulfur used while increasing the amount of vulcanization accelerators, such as CBS (N-cyclohexyl-2-benzothiazole sulfenamide).

The prior art has employed several techniques for improving (increasing) abrasion resistance. One method involves the use of lower T_{g} polymers. The disadvantages are generally reduced wet/dry traction and reduced compounding flexibility. Another method involves increasing the filler loading. The disadvantages are increased hysteresis, reduced compounding flexibility and potential processing difficulties. Another method involves increasing the filler surface area and/or structure. The disadvantages are the same as for increasing the filler loading.

One approach to improving mechanical properties has been the synthesis of bimodal silicone rubber polymers, the distribution of which includes two groups of polymer chains, one having “long” chains and the other having “short” chains. This blend exhibits improved strength and flexural properties with approximately 95% weight short chains. As this method applies only to silicone rubbers, such compositions are not suitable for use in pneumatic tires. Further, this method has not been applied for abrasion resistance or for tires, nor does the method incorporate changes in the distribution of crosslink lengths themselves.

Difunctional crosslinking groups, especially low levels of mercaptans, is known whereby a mercaptan is incorporated into the polymer network. However, the mercaptans are not used as crosslinking agents or curing agents, but rather as crosslink promoters or filler coupling agents in the manufacture of tires. Traditional crosslinking/vulcanizing agents are incorporated as the crosslink agent to the extent of about one or two atoms per crosslink. Use of a difunctional mercaptan as a crosslink promoter does not teach abrasion resistance.

Of course, increasing crosslink density may be achieved simply by adding more sulfur, or vulcanizing accelerator, or by increasing cure temperature or cure time or, combinations thereof. There are practical limits to all of these increases. Merely using large amounts of sulfur in the vulcanization process, e.g., greater than 2-5 phr, can lead to over curing and polysulfidic links, which give poor thermal stability. In general, when the amount of sulfur used exceeds 5 parts by weight, the rubber elasticity is lost.

### SUMMARY OF THE INVENTION

In general the present invention provides a long chain crosslinked elastomeric composition of matter comprising 100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof; from about 1 to about 15 parts by weight of a difunctional crosslinking agent, per 100 parts by weight of the rubber, having the structure Yₘ(SRS)ₙYₘ where Y is selected from the group consisting of H, SR′ and SiR′₃; where R is selected from the group consisting of branched and linear C2 to C20 alkylene, C6 to C20 arylene, C7 to C20 alkyarylene and C4 to C20 cycloalkylene groups and R″XR″; where R′ is selected from the group consisting of branched and linear C1 to C10 alkyl, C6 to C10 aryl, C7 to C10 alkyaryl and C4 to C10 cycloalkyl groups; where R″ is selected from the group consisting of branched and linear C2 to C10 alkylene, C6 to C10 arylene, C7 to C10 alkyarylene and C4 to C10 cycloalkylene groups and R″ can be the same or different; where X is selected from the group consisting of O, S, NH, NR′ and mixtures thereof; where m is 0 or 1 and n is 1 to about 100; from 0 to 5 parts by weight of sulfur; and from about 0.2 to about 10 parts by weight of at least one accelerator.

The present invention also provides a method for making a long chain crosslinked elastomeric composition of matter having long chain polymer backbones and long chain crosslinks which comprises incorporating long chains of a difunctional crosslinking agent into a vulcanizable elastomer composition comprising 100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof; from about 1 to about 15 parts by weight of a difunctional crosslinking agent, per 100 parts by weight of the rubber, having the structure Yₘ(SRS)ₙYₘ where Y is selected from the group consisting of H, SR′ and SiR′₃; where R is selected from the group consisting of branched and linear C2 to C20 alkylene, C6 to C20 arylene, C7 to C20 alkyarylene and C4 to C20 cycloalkylene groups and R″XR″; where R′ is selected from the group consisting of branched and linear C1 to C10 alkyl, C6 to C10 aryl, C7 to C10 alkyaryl and C4 to C10 cycloalkyl groups; where R″ is selected from the group consisting of branched and linear C2 to C10 alkylene, C6 to C10 arylene, C7 to C10 alkyarylene and C4 to C10 cycloalkylene groups and R″ can be the same or different; where X is selected from the group consisting of O, S, NH, NR′ and mixtures thereof; where m is 0 or 1 and n is 1 to about 100; from 0 to 5 parts by weight of sulfur; and from about 0.2 to about 10 parts by weight of at least one accelerator; and vulcanizing said elastomer composition.

The present invention also provides a rubber article manufactured from a long chain crosslinked elastomeric composition of matter having long chain crosslinks which comprises 100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof; from about 1 to about 15 parts by weight of a difunctional crosslinking agent, per 100 parts by weight of the rubber, having the structure Yₘ(SRS)ₙYₘ where Y is selected from the group consisting of H, SR′ and SiR′₃; where R is selected from the group consisting of branched and linear C2 to C20 alkylene, C6 to C20 arylene, C7 to C20 alkyarylene and C4 to C20 cycloalkylene groups and R″XR″; where R′ is selected from the group consisting of branched and linear C1 to C10 alkyl, C6 to C10 aryl, C7 to C10 alkyaryl and C4 to C10 cycloalkyl groups; where R″ is selected from the group consisting of branched and linear C2 to C10 alkylene, C6 to C10 arylene, C7 to C10 alkyarylene and C4 to C10 cycloalkylene groups and R″ can be the same or different; where X is selected from the group consisting of O, S, NH, NR′ and mixtures thereof; where m is 0 or 1 and n is 1 to about 100; from 0 to 5 parts by weight of sulfur; and from about 0.2 to about 10 parts by weight of at least one accelerator.

The present invention further provides a pneumatic tire for use on wheeled vehicles having a component manufactured from a long chain crosslinked elastomeric composition of matter comprises 100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof; from about 1 to about 15 parts by weight of a difunctional crosslinking agent, per 100 parts by weight of the rubber, having the structure Yₘ(SRS)ₙYₘ where Y is selected from the group consisting of H, SR′ and SiR′₃; where R is selected from the group consisting of branched and linear C2 to C20 alkylene, C6 to C20 arylene, C7 to C20 alkyarylene and C4 to C20 cycloalkylene groups and R″XR″; where R′ is selected from the group consisting of branched and linear C1 to C10 alkylene, C6 to C10 arylene, C7 to C10 alkyarylene and C4 to C10 cycloalkylene groups; where R″ is selected from the group consisting of branched and linear C2 to C10 alkylene, C6 to C10 arylene, C7 to C10 alkyarylene and C4 to C10 cycloalkylene groups and R″ can be the same or different; where X is selected from the group consisting of O, S, NH, NR′ and mixtures thereof; where m is 0 or 1 and n is 1 to about 100; from 0 to 5 parts by weight of sulfur; and from about 0.2 to about 10 parts by weight of at least one accelerator.

The present invention also provides a pneumatic tire for use on wheeled vehicles having a component manufactured from a long chain crosslinked elastomeric composition of matter comprising 100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof; from about 1 to about 15 parts by weight of a dimercaptan has the general formula

H(SCH₂CH₂OCH₂CH₂S)ₙH

where n is 2 to 60; from 0 to 5 parts by weight of sulfur; and from about 0.2 to about 10 parts by weight of at least one accelerator.

Advantageously, the present invention provides methods of preparing rubber compositions having desirable properties, such as superior abrasion resistance and thermal stability.

Another advantage of the present invention is to provide a sulfur-vulcanizable, unsaturated elastomer, which contains long chain crosslinks.

Another advantage of the present invention is to provide a method of sulfur vulcanization of rubber, which uses less elemental sulfur as compared to traditional vulcanizing systems.

Another advantage of the present invention is to provide a pneumatic tire comprising a sulfur-vulcanizable, long chain crosslinked elastomer having improved abrasion resistance, and stable crosslinked structures.

It should be apparent from the specification which follows that one or more of the foregoing advantages obtained by this invention over the prior existing art, can be accomplished as hereinafter described and claimed herein.

### DETAILED DESCRIPTION OF ILLUSTRATIVE EMBODIMENTS

As noted above, this invention relates to the preparation of sulfur-vulcanized unsaturated elastomers with long chain crosslinks. More particularly, the present invention relates to the use of difunctional crosslinking agents for the preparation of long chain vulcanized unsaturated elastomer networks having good abrasion resistance and excellent processability. The present invention also provides novel elastomeric compositions suitable for use in a pneumatic tire tread and other tire components and other non-tire products using the difunctional crosslinking agent where the tire tread or other components and products formed from the composition exhibit superior abrasion resistance, and thermal stability.

While there are a number of compounding means to improve the abrasion resistance of rubber compounds, the use of any one approach to improve abrasion resistance is often detrimental to some other property of interest. Thus, those skilled in the art apply a variety of means to achieve an acceptable balance of rubber properties. An intent of the current invention is to provide a novel, additional means by which abrasion resistance can be improved. Consequently, one skilled in the art of rubber compounding would have additional flexibility in the selection of ingredients and in the design of a rubber compound for a particular application.

The novel approach for improved rubber abrasion is to introduce long chain crosslinks into the rubber matrix. Conventional rubber compounds consist of effective network chains, which are long sections (Mₙ may be approximately 10,000 g/mol on average for example) of single polymer chains between crosslinks. Since crosslinking generally occurs at random sites along a polymer chain, there is a distribution of lengths of the effective elastomer network chains. The crosslinks themselves form attachments between polymer chains to give an interconnected network. In traditional or conventional sulfur or other crosslinking systems, there is a distribution of the number of sulfur atoms, for example, bridging two polymer chains to form a crosslink. Thus, there are mono-sulfidic, disulfidic and poly-sulfidic crosslinks, where poly-sulfidic crosslinks may contain up to about eight sulfur atoms. Accordingly, there are two different distributions of lengths in the elastomer network; the distribution of sulfur atoms, or other atoms if the conventional cure system is different from sulfur based, in the individual crosslinks, and the distribution of effective elastomeric chains themselves.

In the present invention, the distribution of crosslinks is different from conventional sulfur or other cure systems, in that either the conventional crosslinks are replaced by a new distribution or crosslinks, whose average length is greater than that of conventional crosslinks, or a second distribution of long crosslinks is introduced, while simultaneously making use of the conventional sulfur or other crosslinking systems as well. Thus, the invention provides lengths in the elastomer matrix consisting of either two separate distributions; 1) effective network chains, and; 2) long crosslinks; or three distributions: 1) effective network chains; 2) long crosslinks, and 3) conventional crosslinks. In the latter case, the distribution of crosslinks themselves is bimodal. In general, the long chain crosslinks in any single rubber application have molecular weights of from about 100 to about 10,000 g/mol with from about 100 to about 5000 being preferred.

The long crosslinks might allow increased slippage of entanglements in the elastomer matrix upon deformation of the rubber article, and consequently provide more effective release of stress upon deformation than conventional, short crosslinks. The release of stress may then provide increased abrasion resistance, as stress concentrations may lead to tearing of the rubber and subsequent removal of rubber from the rubber product. Although it is not known if the proposed mechanism provides a complete or accurate description of the process by which long crosslinks increase abrasion resistance, improved abrasion is nonetheless achieved.

Unexpectedly, the introduction of long crosslinks has provided extraordinary improvements in rubber abrasion resistance. Abrasion resistance with the long crosslink rubber compounds, according to the present invention, have been found to be as much as 13 times that of an identical rubber compound but without the long crosslink cure system, as measured with a laboratory tester using a 50 second test time. Even when the abrasion test is allowed to proceed for 5 minutes, abrasion resistance as much as 3.5 times that of an identical rubber compound, but without the long crosslink cure system, are achieved.

Rubber modulus is known to influence rubber abrasion when measured on the particular laboratory tester, with increasing modulus leading to lower abrasion resistance. However, the current invention provides as much as about 6 times the abrasion resistance as an identical control compound of the same modulus but without the long crosslink cure system, when measured with a laboratory tester and a 50 second test time.

During conventional assessment by usual rubber tests of the rubber compounds with and without the long crosslink cure system, it was found that the long crosslinks tend to be relatively more stable upon aging, compared to a conventional sulfur cure package. That is, when a rubber compound is cured with a long crosslink system and judicious selection is made of the other cure components, tensile strength and elongation at break tend to remain the same or to increase with aging, while a conventional sulfur cure system tends to provide reduced tensile strength and elongation at break upon aging of the rubber compound at elevated temperature. In any case, the long chain crosslink system tends to minimize any decrease in elongation or tensile strength that may occur upon aging, compared to their conventional sulfur cure counterparts. Thus, a second aspect of the invention is the relative thermal stability of the long crosslinks, in comparison to conventional sulfur crosslinking.

In the course of investigating long chain crosslinks, it was unexpectedly found that extraordinary improvements in abrasion resistance can also be achieved through a combination of high benzothiazyl disulfide (MBTS) levels and low sulfur levels, without the presence of long chain crosslinks. Abrasion resistance nearly five times that of a control compound, differing from the high MBTS/low sulfur aspect of the invention only in the cure package, has been achieved. In addition, with judicious selection of the other cure components, tensile strength and elongation at break tend to show less change, or an improvement, with aging, compared to a conventional sulfur cure system.

The long chain crosslinks are derived from the difunctional crosslinking agents and have an average length that is generally shorter than the long chain polymer backbones. As an example, the long chain crosslinks have molecular weights of from about 100 to about 10,000 g/mol. Such polymer network systems are in contrast to those employing sulfur as the cure agent in the formation of mono-, di-, or polysulfidic linkages. There, the crosslinks are actually chains of sulfur atoms, that is, polysulfidic bridges. Inasmuch as a polysulfidic bridge uses more sulfur per crosslink than a monosulfidic link, and as compared with the prior art, the present invention teaches away from prior art inventions incorporating polysulfidic links. The present invention is superior to prior art inventions with polysulfidic links in that polysulfidic links are more susceptible to reversion or thermal hardening as compared to a monosulfidic link, and do not provide the abrasion resistance of this invention.

Illustrative examples of useful unsaturated elastomers, or rubbers, that can be crosslinked with difunctional agents to form long chain polymer networks include, but are not limited to polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof. Any hydrocarbon rubber useful in the manufacture of vulcanizates, as well as functionalized polymers, is useful in terms of the present invention.

The long chain elastomers of the present invention have the structure Yₘ(SRS)ₙYₘ where Y is selected from the group consisting of H, SR′ and SiR′₃; where R is selected from the group consisting of branched and linear C2 to C20 alkylene, C6 to C20 arylene, C7 to C20 alkyarylene and C4 to C20 cycloalkylene groups and R″XR″; where R′ is selected from the group consisting of branched and linear C1 to C10 alkyl, C6 to C10 aryl, C7 to C10 alkyaryl and C4 to C10 cycloalkyl groups; where R″ is selected from the group consisting of branched and linear C2 to C10 alkylene, C6 to C10 arylene, C7 to C10 alkyarylene and C4 to C10 cycloalkylene groups and R″ can be the same or different; where X is selected from the group consisting of O, S, NH, NR′ and mixtures thereof.

Examples of the difunctional crosslinking agents used to form the long chains in the polymer network include the dimercaptans, protected dimercaptans via trialkylsilanes, disulfides or cyclic disulfides, with the protected dimercaptans being preferred. Accordingly, the description which follows will be exemplified and explained with reference to dimercaptans, with the understanding that other difunctional agents, capable of reacting with carbon-carbon double bonds (C═C), can be used in the same manner to form long chain crosslinks across the long chain polymer backbones.

The dimercaptans have the general formula as follows:

HSRSH

where R is selected from the group consisting of branched and linear C2 to C20 alkylene, C6 to C20 arylene, C7 to C20 alkyarylene and C4 to C20 cycloalkylene groups and R″XR″ where R″ is selected from the group consisting of branched and linear C2 to C10 alkylene, C6 to C10 arylene, C7 to C10 alkyarylene and C4 to C10 cycloalkylene groups; where X is selected from the group consisting of O, S, NH, NR′ and mixtures thereof and where R′ is selected from the group consisting of branched and linear C1 to C10 alkylene, C6 to C10 arylene, C7 to C10 alkyarylene and C4 to C10 cycloalkylene groups. A suitable and useful dimercaptan is the Thiokol™ family of prepolymers, which vary from about 1000 g/mol to about 8000 g/mol. Thiokol is a registered trademark. The formula is as follows:

H(SCH₂CH₂OCH₂CH₂S)ₙH

where n is 2 to 60.

The reaction of a dimercaptan with the unsaturated polymer, showing the integration of the crosslinking agent into the unsaturated bonds of the rubber, is depicted below:

2C═C+H(SRS)ₙH→HCC(SRS)ₙCCH Equation 1

This reaction, promoted by Zn and accelerators, proceeds rapidly.

The reaction of the S—S linkage with allyl hydrogen proceeds more slowly and is catalyzed by accelerators:

2n CH₂CH═CH+(SRS)ₙ+Accelerator→n CH═CHCHSRSCHCH═CH Equation 2

Normal sulfur cure proceeds as in Equation 2, except the sulfur starts as cyclic S₈, which gives:

CH₂CH═CH+S₈+Accelerator→CH═CHCHS_{8-X}CHCH═CH Equation 3

The amount of dimercaptan crosslinking agent employed is from about 0.5 to 20 parts per hundred rubber (phr). Using SBR as an example of unsaturated copolymer, the crosslinking reaction with a dimercaptan can be depicted in Scheme I:

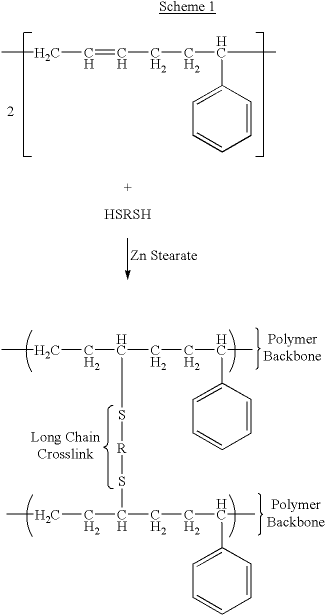

The unsaturated elastomers can optionally be vulcanized with conventional vulcanizing agents, such as sulfur and accelerators. When a vulcanizing agent is used, the amount of the agent used is about 0.1 to about 5 parts by weight, preferably about 0.1 to about 3 parts by weight, based on 100 parts by weight of the rubber material, with a range of from about 0.1 phr to about 2 phr being preferred. When the amount is more than 5 parts by weight, the rubber elasticity is lost.

Representative of conventional accelerators are amines, guanidines, thioureas, thiols, thiurams, sulfonamides, dithiocarbamates and xanthates which are typically added in amounts of from about 0.2 to about 10 phr, with a range of from about 2 phr to about 5 phr being preferred. Representative of sulfur vulcanizing agents include element sulfur (free sulfur) or sulfur donating vulcanizing agents, for example, an amine disulfide, polymeric polysulfide or sulfur olefin adducts. Useful examples include CBS accelerator (N-cyclohexyl-2-benzothiazole sulfenamide), DPG accelerator (diphenyl guanidine) and, for examples in the invention, MBTS accelerator (benzothiazyl disulfide).

The elastomer compositions may also contain conventional additives including reinforcing fillers and non-reinforcing fillers, peptizing agents, pigments, stearic acid, accelerators, sulfur vulcanizing agents, antiozonants, antioxidants, processing oils, activators, initiators, plasticizers, waxes, prevulcanization inhibitors, extender oils, waxes, and the like. Representative of reinforcing agents include carbon black, which is typically added in amounts ranging from about 5 to 100 parts by weight based on 100 parts by weight of total rubber (phr). Preferably, carbon black is used in amounts ranging from about 15 to 85 phr. Typical carbon blacks that are used include N110, N121, N220, N231, N234, N242, N293, N299, N326, N330, N332, N339, N343, N347, N351, N358, N375, N472, N539, N550, N660, N683, N754, and N765. Depending on the particular use of the compound, the appropriate carbon black may be selected.

Typical filler materials also include reinforcing and non-reinforcing fillers conventionally used in vulcanizable elastomeric compounds such as clays, talcs, mica, calcium carbonate, silica and other finely divided mineral materials. Selection of the filler material(s) (mixtures) is not critical to practice of the present invention.

Representative of the antidegradants which may be in the rubber composition include monophenols, bisphenols, thiobisphenols, polyphenols, hydroquinone derivatives, phosphites, phosphate blends, thioesters, naphthylamines, diphenol amines as well as other diaryl amine derivatives, paraphenylene diamines, quinolines and blended amines. Antidegradants are generally used in an amount ranging from about 0.1 phr to about 10 phr with a range of from about 0.5 to 6 phr being preferred.

Representative of a peptizing agent that may be used is pentachlorophenol which may be used in an amount ranging from about 0.1 phr to 0.4 phr with a range of from about 0.2 to 0.3 phr being preferred.

Representative of processing oils which may be used in the rubber composition of the present invention include aliphatic-naphthenic aromatic resins, polyethylene glycol, petroleum oils, ester plasticizers, vulcanized vegetable oils, pine tar, phenolic resins, petroleum resins, polymeric esters and rosins. These processing oils may be used in a conventional amount ranging from about 0 to about 50 phr with a range of from about 5 to 25 phr being preferred.

Zinc oxide and stearic acid are conventionally used to vulcanize elastomers. Zinc oxide is generally used in a conventional amount ranging from about 0.5 to about 5 phr. Stearic acid is generally used in a conventional amount ranging from about 1 to about 4 phr.

The same basic rubber formulation is used throughout the examples, for both the control compounds and the compounds illustrating the invention, with the exception of the cure package or cure system, where the cure package or system may include sulfur, CBS accelerator (N-cyclohexyl-2-benzothiazole sulfenamide), DPG accelerator (diphenyl guanidine) and, for examples in the invention, MBTS accelerator (2-mercaptobenzothiazylsulfide) and Thiokol™ LP31. Table I lists the rubber formulation used throughout the examples.

An unsaturated (elastomeric) composition (SBR) was employed, specifically a solution SBR with 23.5% styrene, 7% vinyl PBD, T_{g} of −59° C. and ML4 of 55. All parts are listed as parts per hundred rubber (phr).

TABLE I
COMPOSITION OF SBR VULCANIZABLE ELASTOMER

| | |
|---|---|
| SBR | 100 |
| Carbon Black | 50 |
| Wax | 1 |
| Tackifier | 2 |
| Antioxidant | 0.95 |
| Aromatic Oil | 15 |
| Stearic Acid | 2 |
| Zinc Oxide | 5 |
| Sulfur | variable (0 to about 5) |
| Accelerator CBS | variable (0 to about 3) |
| Accelerator MBTS | variable (up to about 10) |
| Accelerator DPG | variable (0 to about 2.5) |

Table II is a series of controls identical in composition to the rubber compositions containing long crosslinks, but with conventional sulfur cure packages instead of the long crosslink cure systems. The control series includes a range of sulfur levels at a fixed ratio of CBS accelerator to sulfur, in order to compare at the same low strain dynamic modulus, G′, rubber compounds with a conventional cure package to rubber compounds differing from the control series only in the presence of a long chain crosslink cure system.

TABLE II
CROSSLINKING WITHOUT DIMERCAPTAN

| Example No. | 1 | 2 | 3 | 4 | 5 |
|---|---|---|---|---|---|
| CBS phr | 1.75 | 1.5 | 1.25 | 1 | 0.5 |
| Sulfur phr | 1.75 | 1.5 | 1.25 | 1 | 0.5 |
| DPG | 0.4 | 0.4 | 0.4 | 0.4 | 0.4 |

The five examples were subjected to physical testing and the results have been set forth in Table III. For the present invention, Lambourn Abrasion is used to measure the amount of abrasion of rubber compounds, compared to relevant control compounds. Test specimens are rubber wheels about 48 mm outside diameter, about 22 mm inside diameter and about 4.8 mm thick. The wheels can be prepared by two methods. In the first method, rubber is molded to the wheel dimensions during curing. In the second method, a rectangular rubber slab is cured, then wheels of the proper dimension are cut from the slab using a rotary saw. During cutting, the rubber is lubricated with a mixture of soap and water. In the later case, the wheels are wiped with a cloth after cutting, and allowed to air dry before testing.

Abrasion is induced by rotating the rubber wheel, mounted on an axle, against a counter rotating drum with a diameter of about 173 mm. An abrading surface, 120 grit 3M-ite, is adhered to the circumferential surface of the drum, normal to the drum radius. A load of about 2.5 kg (2 kg weight plus 0.5 kg for the fixture holding the weight) is applied to the rubber wheel during testing. Typically, the rubber wheels are tested at a slip of 65%, which is the difference in tangential velocities of the rubber wheel and the drum, divided by the tangential velocity of the rubber wheel, all multiplied by 100%, and where the tangential velocity of the rubber wheel is based on the rubber wheel diameter before abrasion. In the current examples, all abrasion measurements were made at 65% slip.

A dusting agent, generally talc, is applied during testing to the region where the rubber wheel and abrading surface meet. The talc flow rate is normally about 0.4 grams per minute. Before the abrading surface is applied to experimental compounds, it is first preconditioned. Preconditioning consists of testing six wheels of a typical rubber compound at the conditions above for 50 seconds for each wheel. After the preconditioning step, up to about a total of 150 experimental compound wheels and appropriate control compound wheels can be tested against the same abrading surface. Then the abrading surface is changed to a fresh one, which is also preconditioned before testing experimental and control compounds.

Generally, two rubber wheels, A and B, are tested for each compound, 1, 2, 3 and so on, within an experiment. The wheels are tested in a sequence of 1A, 2A, 3A and so on until one wheel of each compound has been tested. Then the second set of wheels is tested, where the testing sequence by compound number is reversed from that applied to the first set of rubber wheels.

The weight of material abraded from a single rubber wheel can be measured after a single, fixed time, or periodically as the test proceeds. For purposes of the current examples, either or both methods were used. Weight loss due to abrasion was measured either after 50 seconds, or periodically in one minute intervals up to five minutes of abrading time.

For the 50 seconds measurements, the Lambourn Index is 100 times the ratio of control weight loss divided by weight loss of a particular long cross-link rubber compound. For the 5 minutes measurements, the Lambourn Index is 100 times the ratio of control weight loss rate divided by weight loss rate of a particular long crosslink rubber compound. Weight loss rates are determined by measurement of sample weight at 0, 1, 2, 3, 4 and 5 minutes of test time, followed by fitting a straight line by the method of least squares to sample weight as a function of test time. The slope of the least squares curve fit is weight loss rate in mg/minute. Thus, an abrasion index greater than 100 indicates that the experimental compound is better (abrades at a lower rate) than the control compound.

TABLE III
PHYSICAL PROPERTIES OF TABLE II COMPOSITIONS

| Example No. | 1 | 2 | 3 | 4 | 5 |
|---|---|---|---|---|---|
| Lambourn^{a} @ 65% slip, | 0.0940 | 0.0922 | 0.0821 | 0.0540 | 0.0330 |
| g lost | | | | | |
| Lambourn^{a} @ 65% slip, | 98.1 | 100.0 | 112.3 | 170.7 | 279.4 |
| index | | | | | |
| G′ at 14.5% strain and | 1.94 | 1.73 | 1.69 | 1.47 | 1.26 |
| 50° C. (MPa) | | | | | |

^{a}Test time = 50 seconds

The data of Table III were used to estimate the effect of low strain modulus, G′, on Lambourn abrasion resistance. The effect of G′ on Lambourn index was estimated by fitting a second order model to Lambourn index as a function of G′, and gave the result: Lambourn index=1852.62−1894.25G′+510.28(G′)². The empirical curve fit allowed estimation of relative abrasion rates of long chain crosslink compounds, when compared to a control compound with the same low strain modulus, G′, as the long chain crosslink compound.

The next examples have been arranged in a series of four evaluations, I-IV. For each, the SBR composition of Table I was utilized with varying amounts of sulfur, accelerators CBS, MBTS and DPG and Thiokol™ LP 31.

In Evaluation I, 4 compositions were prepared, Example No. 6 containing no Thiokol™ Control) and Examples Nos. 7-9 containing 5-6 phr Thiokol™. (See Table IV).

In Evaluation II, 21 compositions were prepared, Example No. 6 containing no Thiokol™ LP 31 (Control) and Example Nos. 10-19 containing 3 phr (see Tables V and VI) and Example Nos. 20-29 containing 6 phr Thiokol™ LP 31. (See Tables V and VII).

In Evaluation III, the Control, Example No. 6, was compared against two examples with sulfur, Nos. 30 and 31 and three examples without sulfur, Nos. 32, 33 and 34. (See Table VIII).

In Evaluation IV, the Control, Example No. 6 was compared against Example Nos. 35-44, containing 0 phr Thiokol™ LP 31 (see Table IX).

The basic formulation of sulfur and accelerator for Example Nos. 6-29 is presented in Tables IV and V for the data generated in respect of Evaluations I and II. The basic formulation of sulfur, accelerators and Thiokol™ LP 31 for Example Nos. 30-34 is presented in Table VIII for the data generated in respect of Evaluation III. The basic formulation of sulfur and accelerators for Example Nos. 35-39 is presented in Table IX for the data generated in respect of Evaluation IV. In Tables IV, VI, VII, VIII and IX, the Control data (Example No. 6) are from different preparations of the same formulation. Within a table, all examples were prepared and tested in a single group.

TABLE IV
CROSSLINKING WITH DIMERCAPTAN POLYSULFIDE

| Example No. | 6 | 7 | 8 | 9 |
|---|---|---|---|---|
| Description | Control | Long Chain Crosslinking | | |
| Sulfur | 1.5 | 0.4 | 0.3 | 0.2 |
| CBS | 1.5 | 0.4 | 0.3 | 0.2 |
| MBTS | 0.0 | 1.5 | 1.8 | 3.6 |
| DPG | 0.4 | 0.4 | 0.4 | 0.4 |
| Thiokol ™ LP31 | 0.0 | 5.0 | 6.0 | 6.0 |
| Lambourn index, 50 sec. test time, | 100 | 863 | 1280 | 319 |
| universal control | | | | |
| Lambourn index, 5 min. test time, | 100 | 347 | 330 | 294 |
| universal control | | | | |
| Lambourn index, 50 sec. test time, | 100 | 483 | 597 | 206 |
| equal modulus control | | | | |
| Lambourn index, 5 min. test time, | 100 | 194 | 154 | 190 |
| equal modulus control | | | | |
| G′ at 14.5% strain and | 1.81 | 1.45 | 1.37 | 1.51 |
| 50° C. (MPa) | | | | |
| Control stock with G′ equal to | 100 | 179 | 214 | 155 |
| compound in column heading | | | | |
| Cure time at 171° C. (minutes) | 15 | 25 | 25 | 25 |
| Cure Rheometer at 171° C. | | | | |
| ML | 1.51 | 1.56 | 1.53 | 1.48 |
| MH | 13.16 | 7.86 | 6.43 | 8.06 |
| t_{S2} (minutes) | 2.02 | 2.31 | 4.07 | 6.38 |
| t₉₀ (minutes) | 4.00 | 13.94 | 18.74 | 20.14 |
| Tensile Properties at 24° C. | | | | |
| 300% modulus (psi) | 1227 | 606 | 436 | 657 |
| Tensile strength (psi) | 2875 | 1877 | 1316 | 2077 |
| Elongation at break (%) | 547 | 677 | 661 | 669 |

TABLE V
SULFUR AND ACCELERATORS ADDED TO TABLE I COMPOSITION

| | | | | | | | | | | | | | | | | | | | | | |
|---|---|---|---|---|---|---|---|---|---|---|---|---|---|---|---|---|---|---|---|---|---|
| Example No. | 6 | 10 | 11 | 12 | 13 | 14 | 15 | 16 | 17 | 18 | 19 | 20 | 21 | 22 | 23 | 24 | 25 | 26 | 27 | 28 | 29 |
| S | 1.5 | 0.1 | 0.8 | 1.5 | 0.1 | 0.8 | 1.5 | 0.1 | 1.8 | 1.5 | 0.8 | 0.1 | 0.8 | 1.5 | 0.1 | 0.8 | 1.5 | 0.1 | 1.8 | 1.5 | 0.8 |
| CBS | 1.5 | 0.1 | 0.8 | 1.5 | 0.1 | 0.8 | 1.5 | 0.1 | 1.8 | 1.5 | 0.8 | 0.1 | 0.8 | 1.5 | 0.1 | 0.8 | 1.5 | 0.1 | 1.8 | 1.5 | 0.8 |
| MBTS | 0.0 | 1.5 | 1.5 | 1.5 | 3.0 | 3.0 | 3.0 | 4.5 | 4.5 | 4.5 | 4.5 | 1.5 | 1.5 | 1.5 | 3.0 | 3.0 | 3.0 | 4.5 | 4.5 | 4.5 | 4.5 |
| DPG | 0.4 | 0.4 | 0.4 | 0.4 | 0.4 | 0.4 | 0.4 | 0.4 | 0.4 | 0.4 | 0.8 | 0.4 | 0.4 | 0.4 | 0.4 | 0.4 | 0.4 | 0.4 | 0.4 | 0.4 | 0.8 |
| Thiokol ™ LP31 | 0.0 | 3.0 | 3.0 | 3.0 | 3.0 | 3.0 | 3.0 | 3.0 | 3.0 | 3.0 | 3.0 | 6.0 | 6.0 | 6.0 | 6.0 | 6.0 | 6.0 | 6.0 | 6.0 | 6.0 | 6.0 |

### Evaluation I

Evaluation I shows in Table IV the Lambourn Index of rubber compounds containing long crosslinks, where the Lambourn Index is determined after either 50 seconds of abrading time or 5 minutes of abrading time.

Two different controls are used in determination of Lambourn Index for each long crosslink compound. The first control (universal control) is universally applied to all long crosslink rubber compounds irrespective of their modulus. The second control (equal-modulus control) is specific to an individual long crosslink rubber compound, and is estimated from the equation above, based on the data of Table III, at the same low strain dynamic modulus as the corresponding long crosslink rubber compound. Since all Lambourn Indexes, including the equal-modulus controls and the long cross-link rubber compounds, are initially expressed relative to the universal control, the ratio of Lambourn Index, relative to the universal control, of a long crosslink rubber compound to the Lambourn Index of the corresponding equal-modulus control, relative to the universal control, is equal to the Lambourn Index of the long crosslink rubber compound relative to its corresponding equal modulus control.

Table IV shows that large increases in abrasion resistance can be achieved with long chain crosslinking, at both short and long abrading times, and when compared to a universal control or to a control with the same modulus as the long chain crosslink rubber compound. The desired effect can be achieved through various modifications of MBTS and Thiokol™ levels, and of sulfur and CBS levels.

### Evaluation II

Evaluation II further shows in Tables VI and VII that long chain crosslinked rubber provides improved rubber abrasion resistance over a conventional cure package for two very different, 3 and 6 phr, long crosslinking agent levels, when a conventional sulfur cure is contained within the total cure package and judicious selection is made of the other cure components. The increased abrasion resistance can be achieved, in the presence of long chain cross-links, for a variety of levels of other cure components, when the other cure package ingredients are properly selected. Tables VI and VII also show that the presence of the long chain crosslinking agent provides improved retention of tensile strength and elongation upon aging in many cases, compared to the control without the long chain crosslinking agent. Further, presence of the long chain crosslinking agent sometimes provides higher tensile strength and elongation than before aging.

TABLE VI
CROSSLINKING WITH 3 PHR DIMERCAPTAN POLYSULFIDE

| Example No. | 6 | 10 | 11 | 12 | 13 | 14 |
|---|---|---|---|---|---|---|
| S | 1.5 | 0.1 | 0.8 | 1.5 | 0.1 | 0.8 |
| CBS | 1.5 | 0.1 | 0.8 | 1.5 | 0.1 | 0.8 |
| MBTS | 0.0 | 1.5 | 1.5 | 1.5 | 3.0 | 3.0 |
| DPG | 0.4 | 0.4 | 0.4 | 0.4 | 0.4 | 0.4 |
| Thiokol ™ LP31 | 0.0 | 3.0 | 3.0 | 3.0 | 3.0 | 3.0 |
| Lambourn Index^{a} | 100 | 257 | 95 | 99 | 461 | 103 |
| G′ at 14.5% strain and | 1.55 | 0.91 | 1.59 | 2.27 | 1.16 | 1.86 |
| 50° C. (Mpa) | | | | | | |
| Cure time at 171° C. | 14 | 30 | 25 | 25 | 30 25 | |
| (minutes) | | | | | | |
| Cure Rheometer at 171° C. | | | | | | |
| ML | 1.61 | 1.64 | 1.62 | 1.54 | 1.54 | 1.50 |
| MH | 13.65 | 4.90 | 13.05 | 19.22 | 7.41 | 15.62 |
| t_{S2} (minutes) | 1.98 | 6.87 | 1.27 | 0.92 | 7.16 | 1.34 |
| t₉₀ (minutes) | 3.33 | 26.01 | 6.48 | 3.78 | 22.35 | 5.84 |
| Tensile Properties at 24° C. | | | | | | |
| 300% modulus (psi) | 1311 | 285 | 1243 | — | 575 | 1650 |
| Tensile strength (psi) | 2561 | 648 | 2456 | 2046 | 1600 | 2345 |
| % Elongation | 482 | 647 | 489 | 298 | 603 | 380 |
| Break energy, in-lbs/in² | 5263 | 2164 | 5119 | 2604 | 4135 | 3827 |
| % Tensile properties retained | | | | | | |
| after 2 days aging at 100° C., | | | | | | |
| tested at 24° C. Property | | | | | | |
| 300% modulus | 126 | 472 | 101 | — | 87 | 102 |
| Tensile strength | 88 | 344 | 112 | 106 | 107 | 109 |
| % Elongation | 79 | 65 | 106 | 107 | 114 | 107 |
| Break energy | 69 | 176 | 116 | 109 | 122 | 112 |
| Tensile Properties at 100° C. | | | | | | |
| 300% modulus (psi) | — | 139 | — | — | 355 | — |
| Tensile strength (psi) | 985 | 269 | 1041 | 769 | 745 | 983 |
| % Elongation | 301 | 480 | 308 | 174 | 450 | 243 |
| Break energy, in-lbs/in² | 1229 | 560 | 1292 | 572 | 1387 | 979 |
| % Tensile properties retained | | | | | | |
| after 2 days aging at 100° C., | | | | | | |
| tested at 100° C. Property | | | | | | |
| 300% modulus | — | 112 | — | — | 106 | — |
| Tensile strength | 101 | 108 | 101 | 111 | 110 | 119 |
| % Elongation | 75 | 102 | 97 | 109 | 108 | 110 |
| Break energy | 76 | 118 | 95 | 117 | 115 | 128 |
| Example No. | 6 | 15 | 16 | 17 | 18 | 19 |
| S | 1.5 | 1.5 | 0.1 | 1.8 | 1.5 | 0.8 |
| CBS | 1.5 | 1.5 | 0.1 | 1.8 | 1.5 | 0.8 |
| MBTS | 0.0 | 3.0 | 4.5 | 4.5 | 4.5 | 4.5 |
| DPG | 0.4 | 0.4 | 0.4 | 0.4 | 0.4 | 0.8 |
| Thiokol ™ LP31 | 0.0 | 3.0 | 3.0 | 3.0 | 3.0 | 3.0 |
| Lambourn Index^{a} | 100 | 89 | 124 | 107 | 80 | 103 |
| G′ at 14.5% strain and | 1.55 | 2.33 | 1.45 | 2.00 | 2.62 | 2.22 |
| 50° C. (Mpa) | | | | | | |
| Cure time at 171° C. | 14 | 25 | 35 | 25 | 25 25 | |
| (minutes) | | | | | | |
| Cure Rheometer at 171° C. | | | | | | |
| ML | 1.61 | 1.46 | 1.48 | 1.48 | 1.42 | 1.47 |
| MH | 13.65 | 20.96 | 9.12 | 16.92 | 22.29 | 17.91 |
| t_{S2} (minutes) | 1.98 | 0.93 | 7.19 | 1.54 | 0.94 | 1.45 |
| t₉₀ (minutes) | 3.33 | 3.70 | 24.38 | 6.62 | 3.91 | 6.39 |
| Tensile Properties at 24° C. | | | | | | |
| 300% modulus (psi) | 1311 | — | 1006 | 1901 | — | 2070 |
| Tensile strength (psi) | 2561 | 1955 | 2415 | 2370 | 1793 | 2179 |
| % Elongation | 482 | 261 | 551 | 353 | 227 | 313 |
| Break energy, in-lbs/in² | 5263 | 2139 | 5664 | 3498 | 1729 | 2897 |
| % Tensile properties retained | | | | | | |
| after 2 days aging at 100° C., | | | | | | |
| tested at 24° C. Property | | | | | | |
| 300% modulus | 126 | — | 103 | 104 | — | 106 |
| Tensile strength | 88 | 108 | 113 | 101 | 111 | 103 |
| % Elongation | 79 | 91 | 108 | 92 | 97 | 98 |
| Break energy | 69 | 95 | 121 | 92 | 106 | 99 |
| Tensile Properties at 100° C. | | | | | | |
| 300% modulus (psi) | — | — | 584 | — | — | — |
| Tensile strength (psi) | 30985 | 676 | 926 | 849 | 658 | 761 |
| % Elongation | 301 | 139 | 365 | 198 | 133 | 182 |
| Break energy, in-lbs/in² | 1229 | 442 | 1132 | 731 | 402 | 607 |
| % Tensile properties retained | | | | | | |
| after 2 days aging at 100° C., | | | | | | |
| tested at 100° C. Property | | | | | | |
| 300% modulus | — | — | 157 | — | — | — |
| Tensile strength | 101 | 151 | 127 | 106 | 120 | 144 |
| % Elongation | 75 | 109 | 96 | 97 | 94 | 102 |
| Break energy | 75 | 148 | 142 | 98 | 108 | 141 |

^{a}5 min. test time, universal control

TABLE VII
CROSSLINKING WITH 6 PHR DIMERCAPTAN POLYSULFIDE

| Example No. | 6 | 20 | 21 | 22 | 23 | 24 |
|---|---|---|---|---|---|---|
| S | 1.5 | 0.1 | 0.8 | 1.5 | 0.1 | 0.8 |
| CBS | 1.5 | 0.1 | 0.8 | 1.5 | 0.1 | 0.8 |
| MBTS | 0.0 | 1.5 | 1.5 | 1.5 | 3.0 | 3.0 |
| DPG | 0.4 | 0.4 | 0.4 | 0.4 | 0.4 | 0.4 |
| Thiokol ™ LP31 | 0.0 | 6.0 | 6.0 | 6.0 | 6.0 | 6.0 |
| Lambourn Index^{a} | 100 | 130 | 93 | 101 | 414 | 89 |
| G′ at 14.5% strain and | 1.53 | 0.89 | 1.56 | 2.02 | 1.11 | 1.74 |
| 50° C. (MPa) | | | | | | |
| Cure time at 171° C. (minutes) | 14 | 30 | 25 | 25 | 30 25 | |
| Cure Rheometer at 171° C. | | | | | | |
| ML | 1.67 | 1.61 | 1.58 | 1.57 | 1.56 | 1.54 |
| MH | 13.45 | 4.23 | 11.46 | 18.04 | 6.86 | 14.23 |
| t_{S2} (minutes) | 1.95 | 13.37 | 1.24 | 0.84 | 7.69 | 1.4 |
| t₉₀ (minutes) | 3.21 | 27.8 | 8.01 | 4.64 | 23.41 | 7.95 |
| Tensile Properties at 24° C. | | | | | | |
| 300% modulus (psi) | 1252 | 210 | 1133 | 2150 | 490 | 1364 |
| Tensile strength (psi) | 2615 | 431 | 2726 | 2676 | 1432 | 2384 |
| % Elongation | 500 | 717 | 563 | 357 | 652 | 449 |
| Break energy, in-lbs/in² | 5476 | 1787 | 6576 | 4097 | 4141 | 4529 |
| % Tensile properties retained | | | | | | |
| after 2 days aging at 100° C., | | | | | | |
| tested at 24° C. Property | | | | | | |
| 300% modulus | 135 | 128 | 130 | 121 | 119 | 128 |
| Tensile strength | 95 | 163 | 100 | 104 | 133 | 112 |
| % Elongation | 80 | 103 | 85 | 88 | 106 | 92 |
| Break energy | 77 | 150 | 85 | 91 | 140 | 102 |
| Tensile Properties at 100° C. | | | | | | |
| 300% modulus (psi) | 995 | 118 | 889 | — | 331 | — |
| Tensile strength (psi) | 1082 | 201 | 1439 | 1208 | 826 | 1103 |
| % Elongation | 307 | 496 | 411 | 221 | 535 | 297 |
| Break energy, in-lbs/in² | 1409 | 527 | 2383 | 1152 | 1807 | 1321 |
| % Tensile properties retained | | | | | | |
| after 2 days aging at 100° C., | | | | | | |
| tested at 100° C. Property | | | | | | |
| 300% modulus | — | 154 | — | — | 147 | — |
| Tensile strength | 90 | 164 | 83 | 95 | 114 | 96 |
| % Elongation | 77 | 99 | 71 | 83 | 86 | 76 |
| Break energy | 70 | 147 | 60 | 78 | 98 | 79 |
| Example No. | 6 | 25 | 26 | 27 | 28 | 29 |
| S | 1.5 | 1.5 | 0.1 | 1.8 | 1.5 | 0.8 |
| CBS | 1.5 | 1.5 | 0.1 | 1.8 | 1.5 | 0.8 |
| MBTS | 0.0 | 3.0 | 4.5 | 4.5 | 4.5 | 4.5 |
| DPG | 0.4 | 0.4 | 0.4 | 0.4 | 0.4 | 0.8 |
| Thiokol ™ LP31 | 0.0 | 6.0 | 6.0 | 6.0 | 6.0 | 6.0 |
| Lambourn Index^{a} | 100 | 86 | 221 | 88 | 78 | 100 |
| G′ at 14.5% strain and | 1.53 | 2.26 | 1.25 | 1.91 | 2.59 | 2.02 |
| 50° C. (MPa) | | | | | | |
| Cure time at 171° C. (minutes) | 14 | 25 | 35 | 25 | 25 | 25 |
| Cure Rheometer at 171° C. | | | | | | |
| ML | 1.67 | 1.56 | 1.55 | 1.48 | 1.47 | 1.49 |
| MH | 13.45 | 21.2 | 8.29 | 16.31 | 22.74 | 17.94 |
| t_{S2} (minutes) | 1.95 | 0.86 | 8.43 | 1.55 | 0.88 | 1.59 |
| t₉₀ (minutes) | 3.21 | 11.38 | 4.92 | 8.9 | 12.11 | 9.72 |
| Tensile Properties at 24° C. | | | | | | |
| 300% modulus (psi) | 1.67 | — | 778 | 1717 | — | 1828 |
| Tensile strength (psi) | 13.45 | 2187 | 2219 | 2372 | 2078 | 2500 |
| % Elongation | 1.95 | 294 | 615 | 379 | 253 | 379 |
| Break energy, in-lbs/in² | 3.21 | 2713 | 5818 | 3849 | 2245 | 4024 |
| % Tensile properties retained | | | | | | |
| after 2 days aging at 100° C., | | | | | | |
| tested at 24° C. Property | | | | | | |
| 300% modulus | 135 | — | 121 | 115 | — | 112 |
| Tensile strength | 95 | 89 | 115 | 104 | 93 | 94 |
| % Elongation | 80 | 82 | 99 | 94 | 86 | 88 |
| Break energy | 77 | 72 | 114 | 95 | 78 | 82 |
| Tensile Properties at 100° C. | | | | | | |
| 300% modulus (psi) | 995 | — | 573 | — | — | — |
| Tensile strength (psi) | 1081 | 921 | 1151 | 1062 | 772 | 1129 |
| % Elongation | 317 | 183 | 451 | 254 | 146 | 242 |
| Break energy, in-lbs/in² | 1409 | 702 | 2001 | 1093 | 497 | 1123 |
| % Tensile properties retained | | | | | | |
| after 2 days aging at 100° C., | | | | | | |
| tested at 100° C. Property | | | | | | |
| 300% modulus | — | — | 127 | — | — | — |
| Tensile strength | 90 | 90 | 93 | 92 | 90 | 94 |
| % Elongation | 77 | 81 | 84 | 83 | 84 | 85 |
| Break energy | 70 | 76 | 80 | 79 | 76 | 80 |

^{a}5 min. test time, universal control

### Evaluation III

Evaluation III further shows that long chain crosslinked rubber provides improved rubber abrasion resistance over a conventional cure package for two long chain crosslink component levels, when a conventional sulfur cure is included within the total cure package, and also when the total cure package does not include free sulfur and consequently does not include the conventional cure system. Lambourn abrasion resistance almost 5.4 times that of the control is achieved through the use of the long chain crosslinking agent, without sulfur and with adjustment of other cure components. In addition to improved rubber abrasion, improved thermal stability of the long crosslink rubber upon aging, in comparison to the conventional sulfur crosslink system, is also seen. With 24° C. degree testing, tensile strength and elongation at break after aging are maintained or increased over their levels before aging with the long crosslinking agent, while tensile strength and elongation at break of the control is substantially reduced after aging. With 100° C. degree testing, tensile strength and elongation at break after aging are maintained closer to, or increased more than, their levels before aging, with the long chain crosslinking agent in comparison to the control.

TABLE VIII
CROSSLINKING WITH DIMERCAPTAN POLYSULFIDE WITH AND
WITHOUT SULFUR

| Example No. | 6 | 30 | 31 | 32 | 33 | 34 |
|---|---|---|---|---|---|---|
| Sulfur (phr) | 1.5 | 0.1 | 0.1 | 0.0 | 0.0 | 0.0 |
| CBS | 1.5 | 0.1 | 0.1 | 0.0 | 0.0 | 0.0 |
| MBTS | 0.0 | 4.5 | 4.5 | 4.5 | 4.5 | 4.5 |
| DPG | 0.4 | 0.8 | 0.8 | 0.8 | 0.8 | 1.2 |
| Thiokol ™ LP31 | 0.0 | 3.0 | 6.0 | 3.0 | 6.0 | 6.0 |
| Lambourn Index^{a} | 100 | 121 | 219 | 399 | 458 | 538 |
| G′ at 14.5% strain and | 1.64 | 1.48 | 1.34 | 1.40 | 1.27 | 1.17 |
| 50° C. (MPa) | | | | | | |
| Cure time at 171° C. (minutes) | 14 | 35 | 35 | 40 | 40 | 35 |
| Cure Rheometer at 171° C. | | | | | | |
| ML | 1.62 | 1.50 | 1.49 | 1.58 | 1.48 | 1.49 |
| MH | 13.24 | 9.24 | 8.04 | 7.80 | 6.18 | 5.47 |
| t_{S2} (minutes) | 1.95 | 6.91 | 7.97 | 8.43 | 10.01 | 10.12 |
| t₉₀ (minutes) | 3.35 | 21.53 | 23.14 | 28.43 | 26.22 | 29.24 |
| Tensile Properties at 24° C. | | | | | | |
| 300% modulus (psi) | 1237 | 995 | 742 | 701 | 612 | 525 |
| Tensile strength (psi) | 2500 | 2368 | 1965 | 1969 | 1703 | 1589 |
| % Elongation | 503 | 554 | 590 | 618 | 609 | 655 |
| Break energy, in-lbs/in² | 5360 | 5596 | 4974 | 5260 | 4474 | 4552 |
| % Tensile properties retained | | | | | | |
| after 2 days aging at 100° C., | | | | | | |
| tested at 24° C. Property | | | | | | |
| 300% modulus | 131 | 105 | 103 | 105 | 100 | 102 |
| Tensile strength | 92 | 102 | 106 | 100 | 107 | 109 |
| % Elongation | 78 | 100 | 105 | 100 | 107 | 106 |
| Break energy | 73 | 103 | 112 | 102 | 115 | 117 |
| Tensile Properties at 100° C. | | | | | | |
| 300% modulus (psi) | — | 733 | 514 | 472 | 425 | 355 |
| Tensile strength (psi) | 1064 | 1114 | 1020 | 975 | 920 | 901 |
| % Elongation | 314 | 387 | 456 | 467 | 478 | 532 |
| Break energy, in-lbs/in² | 1352 | 1692 | 1819 | 1787 | 1753 | 1929 |
| % Tensile properties retained | | | | | | |
| after 2 days aging at 100° C., | | | | | | |
| tested at 100° C. Property | | | | | | |
| 300% modulus | — | 115 | 121 | 123 | 116 | 154 |
| Tensile strength | 102 | 120 | 110 | 105 | 115 | 157 |
| % Elongation | 81 | 105 | 97 | 93 | 103 | 105 |
| Break energy | 93 | 127 | 110 | 101 | 122 | 169 |

^{a}5 min. test time, universal control

### Evaluation IV

Evaluation IV shows in Table IX that, in the absence of a long chain crosslinking agent, the use of high MBTS levels in combination with low sulfur levels can provide extraordinary, unexpected improvements in abrasion resistance. Combinations of 0.1 phr sulfur and 3.0 phr MBTS (Example No. 38), as well as 0.1 phr sulfur and 4.5 phr MBTS (Example No. 41), provide abrasion resistance about 4.5 times that of the conventional sulfur cured control. In addition, these combinations largely maintain or improve tensile strength and elongation at break upon aging, while the conventional selection of cure components and their levels, provide decreased elongation at break, and tend to provide decreased tensile strength, upon aging.

TABLE IX
CROSSLINKING WITH VARIOUS LEVELS OF MBTS AND SULFUR

| Example No. | 6 | 35 | 36 | 37 | 38 | 39 | 40 | 41 | 42 | 43 | 44 |
|---|---|---|---|---|---|---|---|---|---|---|---|
| S | 1.5 | 0.1 | 0.8 | 1.5 | 0.1 | 0.8 | 1.5 | 0.1 | 1.8 | 1.5 | 0.8 |
| CBS | 1.5 | 0.1 | 0.8 | 1.5 | 0.1 | 0.8 | 1.5 | 0.1 | 1.8 | 1.5 | 0.8 |
| MBTS | 0.0 | 1.5 | 1.5 | 1.5 | 3.0 | 3.0 | 3.0 | 4.5 | 4.5 | 4.5 | 4.5 |
| DPG | 0.4 | 0.4 | 0.4 | 0.4 | 0.4 | 0.4 | 0.4 | 0.4 | 0.4 | 0.4 | 0.8 |
| Lambourn Index^{a} | 100 | 161 | 100 | 105 | 450 | 95 | 98 | 469 | 89 | 89 | 90 |
| G′ at 14.5% Strain and | 1.68 | 0.80 | 1.35 | 1.76 | 1.00 | 1.50 | 1.96 | 1.11 | 1.71 | 2.00 | 1.76 |
| 50° C. (MPa) | | | | | | | | | | | |
| Cure time at 171° C. (minutes) | 14 | 30 | 14 | 14 | 30 | 14 | 14 | 30 | 17 | 14 | 17 |
| Cure Rheometer at 171° C. | | | | | | | | | | | |
| ML | 1.60 | 1.63 | 1.64 | 1.56 | 1.58 | 1.56 | 1.51 | 1.55 | 1.50 | 1.46 | 1.49 |
| MH | 13.49 | 4.09 | 11.57 | 16.87 | 5.70 | 13.49 | 18.87 | 6.41 | 14.77 | 19.87 | 14.91 |
| t_{S2} (minutes) | 1.89 | 10.75 | 1.44 | 1.12 | 5.06 | 1.49 | 1.06 | 5.46 | 1.61 | 1.05 | 1.43 |
| t₉₀ (minutes) | 3.20 | 17.47 | 2.99 | 2.13 | 14.87 | 4.11 | 2.38 | 17.95 | 5.66 | 2.94 | 4.94 |
| Tensile Properties at 24° C. | | | | | | | | | | | |
| 300% modulus (psi) | 1228 | 203 | 933 | 1843 | 308 | 1272 | 2160 | 486 | — | — | 1511 |
| Tensile strength (psi) | 2620 | 363 | 2467 | 2435 | 762 | 2701 | 2260 | 1301 | 2111 | 2066 | 2521 |
| % Elongation | 509 | 681 | 595 | 366 | 642 | 515 | 312 | 634 | 275 | 273 | 436 |
| Break energy, in-lbs/in² | 5573 | 1519 | 5969 | 3726 | 2348 | 5902 | 2966 | 3785 | 2409 | 2339 | 4623 |
| % Tensile properties retained | | | | | | | | | | | |
| after 2 days aging at 100° C., | | | | | | | | | | | |
| tested at 24° C. Property | | | | | | | | | | | |
| 300% modulus | 137 | 125 | 136 | — | 162 | 131 | — | 132 | — | — | 119 |
| Tensile strength | 94 | 161 | 100 | 84 | 178 | 103 | 94 | 139 | 120 | 92 | 94 |
| % Elongation | 79 | 109 | 84 | 74 | 101 | 86 | 85 | 102 | 142 | 83 | 85 |
| Break energy | 75 | 161 | 89 | 61 | 172 | 88 | 78 | 139 | 172 | 76 | 79 |
| Tensile Properties at 100° C. | | | | | | | | | | | |
| 300% modulus (psi) | 990 | 133 | 791 | — | 272 | 1111 | — | 316 | — | — | — |
| Tensile strength (psi) | 1138 | 189 | 1373 | 1013 | 527 | 1301 | 745 | 661 | 1008 | 1088 | 916 |
| % Elongation | 328 | 456 | 430 | 225 | 490 | 333 | 169 | 480 | 269 | 279 | 252 |
| Break energy, in-lbs/in² | 1490 | 547 | 2470 | 961 | 1151 | 1755 | 553 | 1309 | 1075 | 1201 | 926 |
| % Tensile properties retained | | | | | | | | | | | |
| after 2 days aging at 100° C., | | | | | | | | | | | |
| tested at 100° C. Property | | | | | | | | | | | |
| 300% modulus | 0 | 91 | 130 | — | 129 | — | — | 139 | — | — | — |
| Tensile strength | 86 | 117 | 86 | 103 | 131 | 77 | 108 | 135 | 92 | 66 | 117 |
| % Elongation | 76 | 95 | 77 | 85 | 97 | 74 | 91 | 98 | 84 | 48 | 96 |
| Break energy | 67 | 97 | 64 | 86 | 122 | 59 | 95 | 121 | 80 | 36 | 113 |

^{a}5 min. test time, universal control

As is evident from the date presented in the foregoing Tables, the use of long chain crosslinks in the polymer backbone improves the abrasion resistance and thermal stability of the polymer.

Based upon the foregoing disclosure, it should now be apparent that the present invention provides long chain crosslinked elastomeric compositions having improved abrasion resistance. It is to be understood that any variations evident fall within the scope of the claimed invention and, thus, the selection of the specific component elements can be determined without departing from the spirit of the invention herein described and claimed. It should be appreciated that the present invention is not limited to the specific embodiments shown and described hereinabove, but includes variations, modifications and equivalent embodiments defined by the following claims.

What is claimed is:

1. A long chain crosslinked elastomeric composition of matter comprising:
100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof;
from about 1 to about 15 parts by weight of a difunctional crosslinking agent, per 100 parts by weight of the rubber, having the structure Yₘ(SRS)ₙYₘ where Y is selected from the group consisting of H, SR′ and SiR′₃; where R is selected from the group consisting of branched and linear C2 to C20 alkylene, C6 to C20 arylene, C7 to C20 alkyarylene and C4 to C20 cycloalkylene groups and R″XR″; where R′ is selected from the group consisting of branched and linear C1 to C10 alkyl, C6 to C10 aryl, C7 to C10 alkyaryl and C4 to C10 cycloalkyl groups; where R″ is selected from the group consisting of branched and linear C2 to C10 alkylene, C6 to C10 arylene, C7 to C10 alkyarylene and C4 to C10 cycloalkylene groups and R″ can be the same or different; where X is selected from the group consisting of O, S, NH, NR′ and mixtures thereof, where m is 0 or 1 and n is 1 to about 100;
from 0 to 5 parts by weight of sulfur; and
from about 0.2 to about 10 parts by weight of at least one accelerator.

2. A long chain crosslinked elastomeric composition of matter, as set forth in claim 1, wherein said difunctional agent is a dimercaptan having the general formula
HSRSH
where R is selected from the group consisting of branched and linear C2 to C20 alkylene, C6 to C20 arylene, C7 to C20 alkyarylene and C4 to C20 cycloalkylene groups and R″XR″ where R″ is selected from the group consisting of branched and linear C2 to C10 alkylene, C6 to C10 arylene, C7 to C10 alkyarylene and C4 to C10 cycloalkylene groups; where X is selected from the group consisting of O,
S, NH, NR′ and mixtures thereof and where R′ is selected from the group consisting of branched and linear C1 to C10 alkylene, C6 to C10 arylene, C7 to C10 alkyarylene and C4 to C10 cycloalkylene groups.

3. A long chain crosslinked elastomeric composition of matter, as set forth in claim 2, wherein said dimercaptan has the general formula
H(SCH₂CH₂OCH₂CH₂S)ₙH
where n is 2 to 60.

4. A long chain crosslinked elastomeric composition of matter, as set forth in claim 1, wherein said long chain difunctional crosslinking agent has a molecular weight of about 100 to about 10,000 g/mol.

5. A long chain crosslinked elastomeric composition of matter, as set forth in claim 1, wherein said accelerators are selected from the group consisting of amines, guanidines, thioureas, thiols, thiurams, sulfonamides, dithiocarbamates and xanthates.

6. A method for making a long chain crosslinked elastomeric composition of matter having long chain polymer backbones and long chain crosslinks, comprising:
incorporating long chains of a difunctional crosslinking agent into a vulcanizable elastomer composition comprising 100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof;
from about 1 to about 15 parts by weight of a difunctional crosslinking agent, per 100 parts by weight of the rubber, having the structure Yₘ(SRS)ₙYₘ where Y is selected from the group consisting of H, SR′ and SiR′₃; where R is selected from the group consisting of branched and linear C2 to C20 alkylene, C6 to C20 arylene, C7 to C20 alkyarylene and C4 to C20 cycloalkylene groups and R″XR″; where R′ is selected from the group consisting of branched and linear C1 to C10 alkyl, C6 to C10 aryl, C7 to C10 alkyaryl and C4 to C10 cycloalkyl groups; where R″ is selected from the group consisting of branched and linear C2 to C10 alkylene, C6 to C10 arylene, C7 to C10 alkyarylene and C4 to C10 cycloalkylene groups and R″ can be the same or different; where X is selected from the group consisting of O, S, NH, NR′ and mixtures thereof; where m is 0 or 1 and n is 1 to about 100;
from 0 to 5 parts by weight of sulfur; and
from about 0.2 to about 10 parts by weight of at least one accelerator; and vulcanizing said elastomer composition.

7. A method, as set forth in claim 6, wherein said difunctional agent is a dimercaptan having the general formula
HSRSH
where R is selected from the group consisting of branched and linear C2 to C20 alkylene, C6 to C20 arylene, C7 to C20 alkyarylene and C4 to C20 cycloalkylene groups and R″XR″ where R″ is selected from the group consisting of branched and linear C2 to C10 alkylene, C6 to C10 arylene, C7 to C10 alkyarylene and C4 to C10 cycloalkylene groups; where X is selected from the group consisting of O, S, NH, NR′ and mixtures thereof and where R′ is selected from the group consisting of branched and linear C1 to C10 alkylene, C6 to C10 arylene, C7 to C10 alkyarylene and C4 to C10 cycloalkylene groups.

8. A method, as set forth in claim 7, wherein said dimercaptan has the general formula
H(SCH₂CH₂OCH₂CH₂S)ₙH
where n is 2 to 60.

9. A method, as set forth in claim 6, wherein said accelerators are selected from the group consisting of amines, guanidines, thioureas, thiols, thiurams, sulfonamides, dithiocarbamates and xanthates.

10. A rubber article manufactured from a long chain crosslinked elastomeric composition of matter comprising:
100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof;
from about 1 to about 15 parts by weight of a difunctional crosslinking agent, per 100 parts by weight of the rubber, having the structure Yₘ(SRS)ₙYₘ where Y is selected from the group consisting of H, SR′ and SiR′₃; where R is selected from the group consisting of branched and linear C2 to C20 alkylene, C6 to C20 arylene, C7 to C20 alkyarylene and C4 to C20 cycloalkylene groups and R″XR″; where R′ is selected from the group consisting of branched and linear C1 to C10 alkyl, C6 to C10 aryl, C7 to C10 alkyaryl and C4 to C10 cycloalkyl groups; where R″ is selected from the group consisting of branched and linear C2 to C10 alkylene, C6 to C10 arylene, C7 to C10 alkyarylene and C4 to C10 cycloalkylene groups and R″ can be the same or different; where X is selected from the group consisting of O, S, NH, NR′ and mixtures thereof; where m is 0 or 1 and n is 1 to about 100;
from 0 to 5 parts by weight of sulfur; and
from about 0.2 to about 10 parts by weight of at least one accelerator.

11. A rubber article, as set forth in claim 11, wherein said difunctional agent is a dimercaptan having the general formula
HSRSH
where R is selected from the group consisting of branched and linear C2 to C20 alkylene, C6 to C20 arylene, C7 to C20 alkyarylene and C4 to C20 cycloalkylene groups and R″XR″ where R″ is selected from the group consisting of branched and linear C2 to C10 alkylene, C6 to C10 arylene, C7 to C10 alkyarylene and C4 to C10 cycloalkylene groups; where X is selected from the group consisting of O, S, NH, NR′ and mixtures thereof and where R′ is selected from the group consisting of branched and linear C1 to C10 alkylene, C6 to C10 arylene, C7 to C10 alkyarylene and C4 to C10 cycloalkylene groups.

12. A rubber article, as set forth in claim 12, wherein said dimercaptan has the general formula
H(SCH₂CH₂OCH₂CH₂S)ₙH
where n is 2 to 60.

13. A rubber article, as set forth in claim 11, wherein said long chain difunctional crosslinking agent has a molecular weight of about 100 to about 10,000 g/mol.

14. A rubber article, as set forth in claim 11, wherein said accelerators are selected from the group consisting of amines, guanidines, thioureas, thiols, thiurams, sulfonamides, dithiocarbamates and xanthates.

15. A pneumatic tire for use on wheeled vehicles having a component manufactured from a long chain crosslinked elastomeric composition of matter comprising:
100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof;
from about 1 to about 15 parts by weight of a difunctional crosslinking agent, per 100 parts by weight of the rubber, having the structure Yₘ(SRS)ₙYₘ where Y is selected from the group consisting of H, SR′ and SiR′₃; where R is selected from the group consisting of branched and linear C2 to C20 alkylene, C6 to C20 arylene, C7 to C20 alkyarylene and C4 to C20 cycloalkylene groups and R″XR″; where R′ is selected from the group consisting of branched and linear C1 to C10 alkyl, C6 to C10 aryl, C7 to C10 alkyaryl and C4 to C10 cycloalkyl groups; where R″ is selected from the group consisting of branched and linear C2 to C10 alkylene, C6 to C10 arylene, C7 to C10 alkyarylene and C4 to C10 cycloalkylene groups and R″ can be the same or different; where X is selected from the group consisting of O, S, NH, NR′ and mixtures thereof; where m is 0 or 1 and n is 1 to about 100;
from 0 to 5 parts by weight of sulfur; and
from about 0.2 to about 10 parts by weight of at least one accelerator.

16. A pneumatic tire, as set forth in claim 16, wherein said difunctional agent is a dimercaptan having the general formula
HSRSH
where R is selected from the group consisting of branched and linear C2 to C20 alkylene, C6 to C20 arylene, C7 to C20 alkyarylene and C4 to C20 cycloalkylene groups and R″XR″ where R″ is selected from the group consisting of branched and linear C2 to C10 alkylene, C6 to C10 arylene, C7 to C10 alkyarylene and C4 to C10 cycloalkylene groups; where X is selected from the group consisting of O, S, NH, NR′ and mixtures thereof and where R′ is selected from the group consisting of branched and linear C1 to C10 alkylene, C6 to C10 arylene, C7 to C10 alkyarylene and C4 to C10 cycloalkylene groups.

17. A pneumatic tire, as set forth in claim 17, wherein said dimercaptan has the general formula
H(SCH₂CH₂OCH₂CH₂S)ₙH
where n is 2 to 60.

18. A pneumatic tire, as set forth in claim 16, wherein said long chain difunctional crosslinking agent has a molecular weight of about 100 to about 10,000 g/mol.

19. A pneumatic tire, as set forth in claim 16, wherein said accelerators are selected from the group consisting of amines, guanidines, thioureas, thiols, thiurams, sulfonamides, dithiocarbamates and xanthates.

20. A pneumatic tire for use on wheeled vehicles having a component manufactured from a long chain crosslinked elastomeric composition of matter comprising:
100 parts by weight of a rubber selected from the group consisting of polybutadiene, styrene-butadiene rubber, synthetic cis-1,4-polyisoprene, synthetic polyisoprene, cis-polybutadiene, butadiene-isoprene rubber, styrene-isoprene rubber, styrene-isoprene-butadiene rubber, butyl rubber, neoprene, acrylonitrile-butadiene rubber, natural rubber, EPDM, terminal and backbone functionalized derivatives thereof, and mixtures thereof;
from about 1 to about 15 parts by weight of a dimercaptan, per 100 parts by weight of the rubber, having the general formula
H(SCH₂CH₂OCH₂CH₂S)ₙH
where n is 2 to 60;
from 0 to 5 parts by weight of sulfur; and
from about 0.2 to about 10 parts by weight of at least one accelerator.
